(19) United States
(12) Patent Application Publication
(10) Pub. No.: US 2007/0173094 A1
(43) Pub. Date: Jul. 26, 2007

(54) Tail structure of electric wire

(76) Inventors: Po-Chao Tan, Chung-Ho City (TW); Yen Liu, Chung-Ho City (TW)

Correspondence Address: HDSL, 4331 STEVENS BATTLE LANE, FAIRFAX, VA, 22033, US

(21) Appl. No.: 10/685,451

(22) Filed: Oct. 16, 2003

(51) Int. Cl. H01R 4/60

(52) U.S. Cl. 439/214

(57) ABSTRACT

An improved tail structure of an electric wire. The tail structure has a hard terminal with one end connected to a soft electric wire. The junction between the hard terminal and the soft electric wire has a softened buffering structure. The periphery of the hard terminal is wrapped with a soft layer, which extends across the junction to wrap a part of the periphery of the electric wire as well as the buffering structure, such that the junction of the hard terminal and the electric wire is reinforced.

### BACKGROUND OF THE INVENTION

The present invention relates to a tail structure of an electric wire, and more particularly, to an improved tail structure of an electric wire used as the output terminal of a source line, signal line, or a testing probe. The strength of the improved tail structure is enhanced, such that the lifetime thereof is lengthened.

FIG. 1 shows a conventional testing probe of a multi-meter. The testing probe 10 includes a measuring terminal 101 to be in electric contact with an object. The measuring terminal 101 is typically made of conductive material for measuring the required electric data of the object. Therefore, the electric characteristics of the object can be read. The measuring terminal 101 is connected to a soft electric wire 103 to transmit the electric data measured by the measuring terminal 101. Adjacent to the measuring terminal 101, a handling part 102 made of hard insulating material is formed to wrap around the soft electric wire 103. At the distal end of the handling part 102, a buffering structure 104 is formed allowing the user to bend or twist the soft electric wire 103.

However, the hard handling part 102 is typically made too long to restrict the maneuver of the testing probe 10. That is, often time the testing probe 10 cannot be twisted or bent as required, or the electric wire 103 is easily broken. On the other hand, the length of the buffering structure 104 is insufficient to provide enough flexibility of bending or twisting the testing probe 10. Similar effects are thus likely resulted.

### BRIEF SUMMARY OF THE INVENTION

The present invention provides an improved tail structure of an electric wire which uses a soft layer to wrap around the tail of the electric wire, such that the overall bending and stretching strength is increased, and the lifetime of the electric wire is lengthened. Further, the leakage from breakage of the electric wire caused by overly bending the tail of the electric wire is prevented.

The improved tail structure provided by the present invention comprises a hard terminal with one end connected to a soft electric wire. A buffering structure is formed covering the junction between the hard terminal and the soft electric wire, and a soft layer is used to wrap around the periphery of the hard terminal. The soft layer extends across the buffering layer to seal a part of the electric wire uncovered by the buffering layer.

### BRIEF DESCRIPTION OF THE DRAWINGS

These, as well as other features of the present invention, will become apparent upon reference to the drawings wherein:

FIG. 1 shows a perspective view of a conventional testing probe;

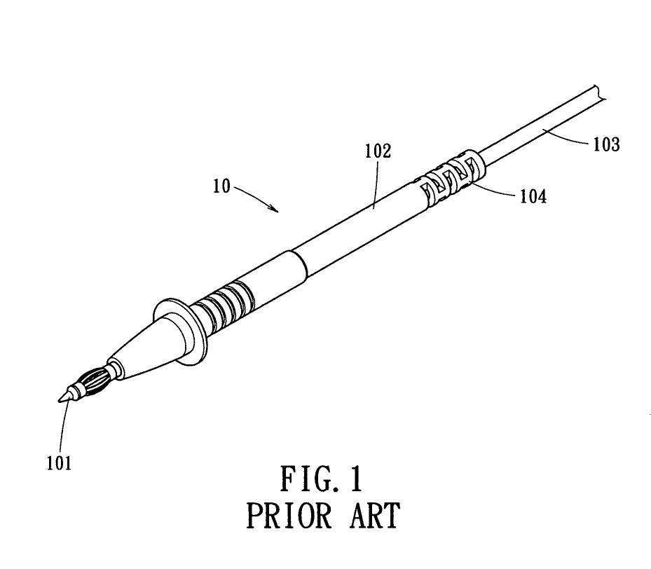

FIG. 2 shows an exploded view of an improved tail structure according to the present invention;

FIG. 3 shows the assembly of the improved tail structure;

FIG. 4 shows the exterior features of the improved tail structure; and

FIG. 5 shows a cross sectional view of the improved tail structure.

### DETAILED DESCRIPTION OF THE INVENTION

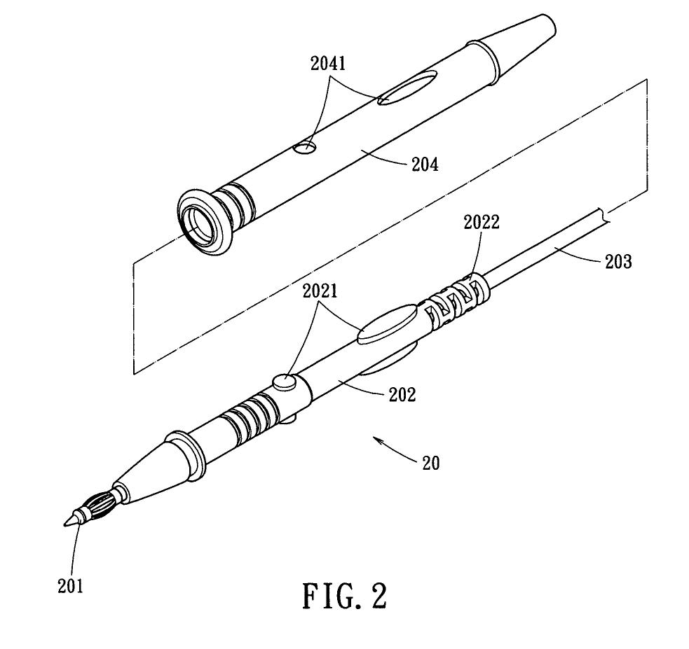

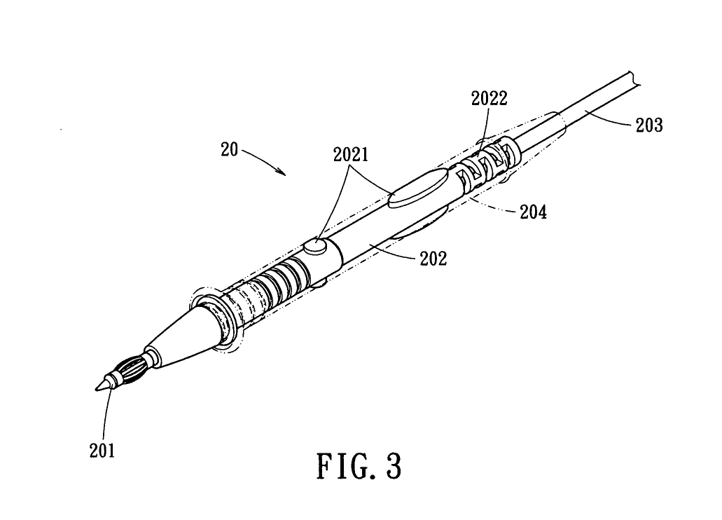

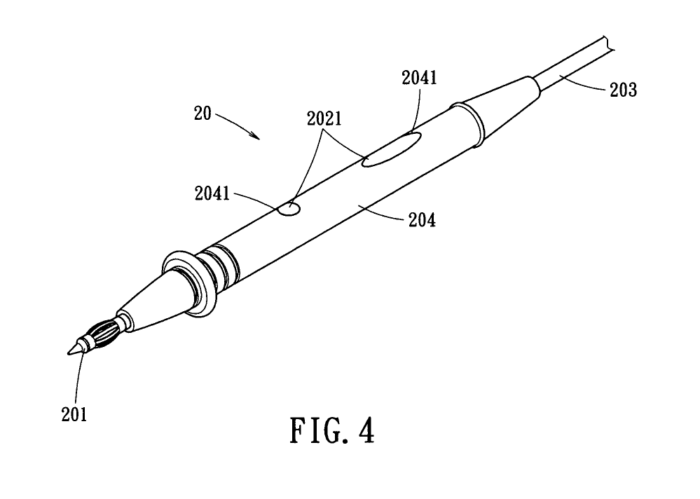

Referring to FIGS. 2, 3 and 4, exploded view, assembly schematic, and exterior features of an improved tail structure of an electric wire are illustrated. The improved tail structure provided by the present invention is suitable to use in a power source line, a signal line, and a testing probe. In the embodiment as shown in FIGS. 2, 3 and 4, the improved tail structure is applied to a testing probe. The testing probe 20 as shown includes a conductive filament (not shown) wrapped with a hard material 202 for insulation. One end of the conductive filament protrudes from the hard material 202 as a measuring terminal 201, while the other end of the conductive filament is electrically connected to a bare part of a soft electric wire 203. Therefore, when the measuring terminal 201 detects any electric data from an object, such electric data can be transmitted through the soft electric wire 203 to a testing device such as a multi-meter.

The hard material has a hand-held length for a user. As the conductive filament is electrically connected to the bare portion of the soft electric wire 203, a buffering structure 2022 is formed across the junction between the hard material 202 and the soft electric wire 203. The buffering structure 2022 has been softened with predetermined softness and specific folding and bending capability. Therefore, the soft electric wire 203 wrapped thereby can follow the bending direction of the buffering structure, while the bending radius of the soft electric wire 203 is not overly small. Therefore, the folding damage of the bare part of the soft electric wire 203 is prevented.

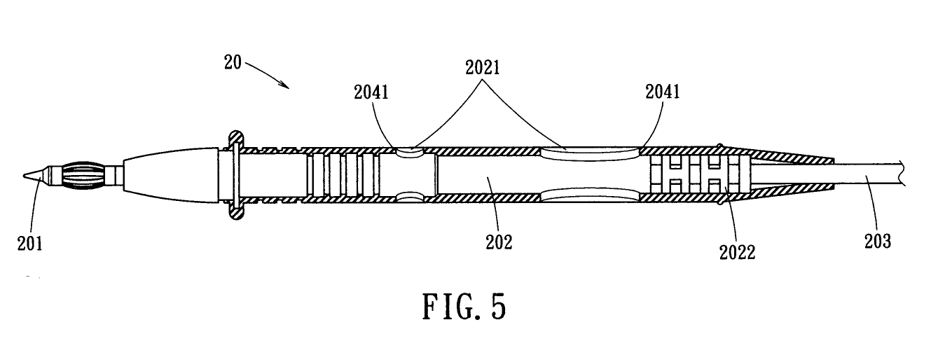

As shown in FIG. 5, the hard material is further covered by a soft layer 204. Preferably, the soft layer 204 is made of bendable and foldable material such as plastic or rubber. The soft layer 204 extends across the buffering structure 2022 to the soft electric wire 203. Therefore, the hard material 202, the buffering structure 2202 and a part of the soft electric wire 203 are wrapped by the soft layer 204. The connection strength between the hard material 202 and the soft electric wire 203 is thus enhanced to prevent from breaking or peeling the soft electric wire 203 off by iterative stretch, folding and bending operations. Further, the folding and bending capability of the testing probe 20 is doubled, and the lifetime thereof is increased.

To further improve the connection strength of the soft layer 204 wrapping around the testing bar 20, a snapping mechanism 2021 may be formed to protrude from the hard material 202. A corresponding hole 2041 is formed in the soft layer 204 snapping mechanism 2021 to engage with the snapping mechanism 2021. Therefore, the soft layer 204 can be stably applied to the testing probe 20.

The improved tail structure as described above can also be applied to a power source cord or a testing line. For a power source plug of a typical electric appliance, the hard material 202 includes the plastic insulating material (normally black) covering the pins, while the measuring terminal 201 is equivalent to the pins. Therefore, the soft layer 204 can also be applied to a conventional plug of an electric appliance.

Therefore, the present invention has at least the following advantages.

1. The overall bending and stretching strength of the electric wire is enhanced.

2. The lifetime of the tail of the electric wire is increased.

3. The leakage caused by breakage of the tail of electric wire is prevented.

This disclosure provides exemplary embodiments of the present invention. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. A tail structure of an electric wire, comprising a hard terminal with one end connected to a soft electric wire; a buffering structure wrapping around a junction of the hard terminal and the soft electric wire; and a soft layer wrapping around the hard terminal, wherein the soft layer extends across the buffering structure to the soft electric wire, such that the buffering structure and a part of the soft electric wire are wrapped thereby.

2. The tail structure according to claim 1, wherein the hard terminal includes the other end serving as a measuring terminal.

3. The tail structure according to claim 1, wherein the hard terminal includes a snapping mechanism protruding therefrom, and the soft layer includes a hole formed therein to engage with the snapping mechanism.

4. The tail structure according to claim 1, wherein the soft layer is fabricated from plastic.

5. The tail structure according to claim 1, wherein the soft layer is fabricated from rubber.

6. A testing probe, comprising:
a hand-held portion;
a measuring terminal protruding from a first end of the hand-held portion;
a soft electric wire connected to a second end of the hand-held portion, the soft electric wire being electrically connected to the measuring terminal;
a buffering structure wrapping a junction between the hand-held portion and the soft electric wire, the buffering structure having a predetermined softness allowing the soft electric wire wrapped thereby to bend therewith;
a removable soft layer wrapping at least a portion of the hand-held portion, the entire buffering structure and at least a portion of the electric wire.

7. The testing probe according to claim 6, wherein the hand-held portion is fabricated from hard insulation material.

8. The testing probe according to claim 6, further comprising a conductive filament extending from the measuring terminal to a bare portion of the soft electric wire within the hand-held portion.

9. The testing probe according to claim 6, wherein the removable soft layer is secured to the hand-held portion by at least one snapping mechanism.
